(19) United States
(12) Patent Application Publication
(10) Pub. No.: US 2024/0037993 A1
(43) Pub. Date: Feb. 1, 2024

(54) VIDEO PROCESSING METHOD ARRANGED TO PERFORM PARTIAL HIGHLIGHTING WITH AID OF HAND GESTURE DETECTION AND ASSOCIATED SYSTEM ON CHIP

(71) Applicant: Realtek Semiconductor Corp., HsinChu (TW)

(72) Inventor: Chia-Chun Cheng, HsinChu (TW)

(73) Assignee: Realtek Semiconductor Corp., HsinChu (TW)

(21) Appl. No.: 18/226,236

(22) Filed: Jul. 25, 2023

(30) Foreign Application Priority Data
Jul. 26, 2022 (TW) 111127891

(51) Int. Cl. G06V 40/20; G06V 40/10; G06V 10/25; G06T 3/40; G10L 17/02; G10L 25/78; G10L 17/10

(52) U.S. Cl. CPC G06V 40/28; G06V 40/10; G06V 10/25; G06T 3/40; G10L 17/02; G10L 25/78; G10L 17/10

(57) ABSTRACT

A video processing method for performing partial highlighting with the aid of hand gesture detection and an associated SoC are provided. The SoC includes a person recognition circuit, a hand gesture detection circuit, a sound detection circuit and a processing circuit. The person recognition circuit obtains image data from an image capturing device, and performs person recognition on the image data to generate a recognition result. The hand gesture detection circuit performs hand gesture detection on hand gesture image data to generate a hand gesture detection result. The sound detection circuit receives multiple sound signals from multiple microphones, and determines a voice characteristic value of a main sound. The processing circuit determines a specific region in the image data according to the recognition result, the hand gesture detection result, and the voice characteristic value, and processes the image data to highlight the specific region.

### BACKGROUND OF THE INVENTION

### 1. Field of the Invention

The present invention is related to a method of video processing for live streaming, and more particularly, to a video processing method that is arranged to perform partial highlighting with the aid of hand gesture detection and an associated system on chip (SoC).

### 2. Description of the Prior Art

Live streaming is widely used in modern society, and has seen a particular rise in popularity during the Covid-19 pandemic when face-to-face meetings were replaced with remote video conferences. When one party in a remote video conference includes multiple participants that can be seen in an image (e.g. an image displayed on a screen), it may be difficult for the other party's participants to distinguish a speaker. Specifically, assume that a current remote video conference is taking place between a first party and a second party, wherein the first party has multiple participants in a physical conference room, and the audio and video information of the physical conference room is captured by a microphone and camera and transmitted to participants in the remote second party through a network. Due to the relative positioning of the multiple participants in the first party and limitations with regards to the size of the image, the participants of the second party may not be able to correctly identify a current speaker within the image, such that the participants of the second party may be confused as to whom the current speaker is, thereby affecting efficiency of the conference.

### SUMMARY OF THE INVENTION

It is therefore one of the objectives of the present invention to provide a person tracking technology that can be applied to a remote video, wherein a current speaker in an image (e.g. an image displayed on a screen) can be highlighted, to address the above-mentioned issues.

According to an embodiment of the present invention, an SoC that is arranged to perform partial highlighting with the aid of hand gesture detection is provided. The SoC comprises a person recognition circuit, a hand gesture detection circuit, a sound detection circuit, and a processing circuit. The person recognition circuit is arranged to obtain an image data from an image capturing device, and perform person recognition upon the image data to generate a recognition result. The hand gesture detection circuit is arranged to obtain the image data from the image capturing device, and perform hand gesture detection upon a hand gesture image data in the image data to generate a hand gesture detection result. The sound detection circuit is arranged to receive multiple sound signals from multiple microphones, and determine a voice characteristic value of a main sound. The processing circuit is coupled to the person recognition circuit, the hand gesture detection circuit, and the sound detection circuit, and is arranged to determine a specific region in the image data according to the recognition result, the gesture detection result, and the voice characteristic value of the main sound, and process the image data to highlight the specific region.

According to an embodiment of the present invention, a video processing method that is arranged to perform partial highlighting with the aid of hand gesture detection is provided. The video processing method comprises: obtaining an image data from an image capturing device, and performing person recognition upon the image data to generate a recognition result; obtaining the image data from the image capturing device, and performing hand gesture detection upon hand gesture image data in the image data, to generate a hand gesture detection result; receiving multiple sound signals from multiple microphones, and determining a voice characteristic value of a main sound; determining a specific region in the image data according to the recognition result, the gesture detection result, and the voice characteristic value of the main sound; and processing the image data to highlight the specific region.

One of the benefits of the present invention is that by detecting the current speaker and highlighting the speaker in the image data, the video processing method and the SoC of the present invention can enable participants in the remote conference room to clearly identify the speaker, which can effectively improve the conference efficiency. In addition, the video processing method and the SoC of the present invention can ensure the accuracy of related operations by hand gesture detection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a remote video conference according to an embodiment of the present invention.

FIG. 2 is a diagram illustrating an electronic device according to an embodiment of the present invention.

FIG. 3 is a flow chart of a video processing method according to an embodiment of the present invention.

FIG. 4 is a diagram illustrating a person recognition circuit that recognizes multiple people in an image (e.g. an image displayed on a screen) according to an embodiment of the present invention.

FIG. 5 is a diagram of highlighting a current speaker in an image according to an embodiment of the present invention.

FIG. 6 is a diagram illustrating a predetermined hand gesture according to an embodiment of the present invention.

FIG. 7 is a diagram illustrating a predetermined hand gesture according to another embodiment of the present invention.

### DETAILED DESCRIPTION

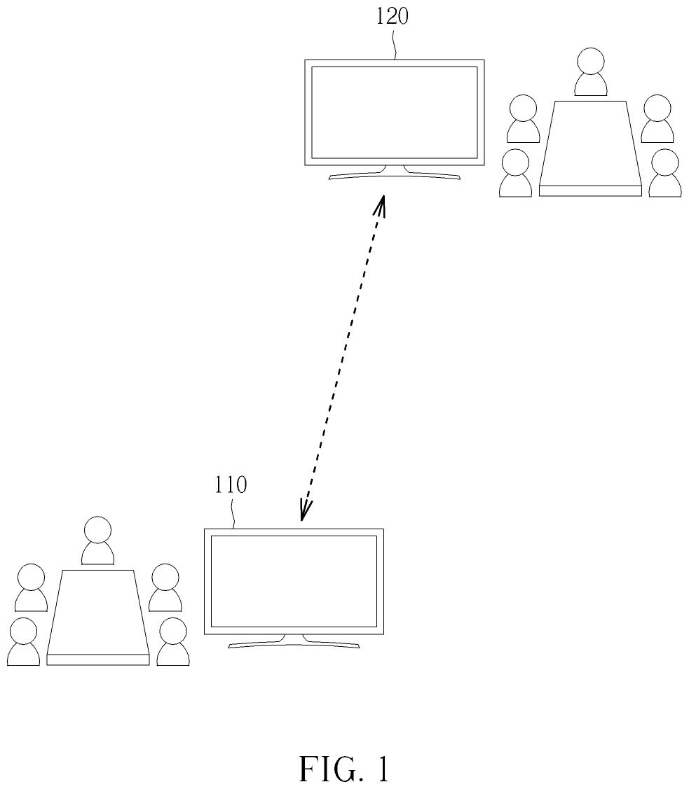

FIG. 1 is a diagram illustrating a remote video conference according to an embodiment of the present invention. As shown in FIG. 1, an electronic device 110 is in a first conference room for real-time capturing of an image of the first conference room and real-time recording of sound in the first conference room, and the information is transmitted to a second conference room through a network to make an electronic device 120 in the second conference room play the video and sound of the first conference room. Simultaneously, the electronic device 120 in the second conference room also captures an image of the second conference room and records sound in the second conference room in real time, and transmits the information to the first conference room through the network so that electronic device 110 in the first conference room plays the video and sound of the second conference room. In this embodiment, the electronic devices 110 and 120 can be any electronic device with an image and audio transmission and reception function and a network communication function, such as a television (TV), a laptop, a tablet, a cellphone, etc.

When one party in a remote video conference includes multiple participants in an image (e.g. an image displayed on a screen), the other party's participants may sometimes have difficulty distinguishing a current speaker from among the participants in the image. For example, if the participants in the second conference room are not familiar with the respective voices of the participants in the first conference room, or if the speaker in the first conference room is not facing the camera, the participants in the second conference room may sometimes find it difficult to identify the speaker, which can result in communication difficulties.

A method for highlighting the speaker is designed in a system on chip (SoC) in the electronic device 110, so that the participants in the second conference room can clearly identify the speaker in the first conference room, to address the above-mentioned issues.

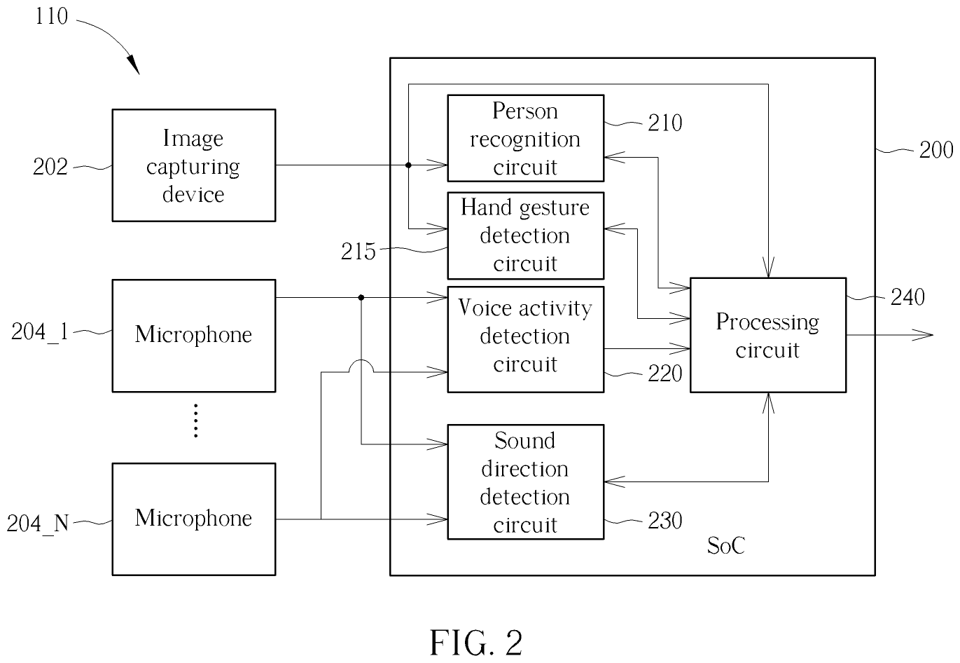

FIG. 2 is a diagram illustrating the electronic device 110 according to an embodiment of the present invention. As shown in FIG. 2, the electronic device 110 includes an SoC 200, an image capturing device 202, and multiple microphones 204_1-204_N, wherein N is a positive integer greater than 1. In addition, the SoC 200 includes a person recognition circuit 210, a hand gesture detection circuit 215, a voice activity detection circuit 220, a sound detection circuit (e.g. a sound direction detection circuit 230), and a processing circuit 240. In this embodiment, the image capturing device 202 may be a camera or a video camera, which continuously captures the image in the first conference room in real time to generate and transmit an image data to the SoC 200, wherein the image data received by the SoC 200 can be an original image data or a data that has undergone some image processing operations. The microphones 204_1-204_N may be digital microphones which are placed at different locations of the electronic device 110, to generate and transmit multiple sound signals to the SoC 200, respectively.

It should be noted that the image capturing device 202 and the microphones 204_1-204_N are disposed in the electronic device 110; however, in some embodiments, the image capturing device 202 and the microphones 204_1-204_N are externally connected to the electronic device 110.

The person recognition circuit 210 is arranged to perform person recognition upon the image data received by the image capturing device 202, to first determine whether there is a person/people in the received image data, and determine a characteristic value of each person and a position/region of each person in the image (e.g. the image displayed on the screen). Specifically, the person recognition circuit 210 may utilize a deep learning method or a neural network method to process at least one frame in the image data. For example, multiple different convolution kernels (e.g. convolution filters) are utilized to perform multiple convolution operations upon the at least one frame (e.g. an image frame) to recognize whether there is a person in the at least one frame. In addition, for a detected person, a characteristic value of the detected person (or a characteristic value of a region in which the detected person is located) is determined by the above-mentioned deep learning method or neural network method, wherein the characteristic value can be a multi-dimensional vector (e.g. a vector with dimension “512”). It should be noted that the above-mentioned circuit design related to person recognition is well known to those with ordinary knowledge in the art. One of the key points of this embodiment is the application of people recognized by the person recognition circuit 210 and their characteristic values. Other details of the person recognition circuit 210 are not repeated here.

The hand gesture detection circuit 215 is arranged to perform hand gesture detection upon a hand gesture image data in the image data received by the image capturing device 202 to generate at least one hand gesture detection result. More particularly, the hand gesture detection circuit 215 may include multiple sub-circuits for a two-stage operation, which are expressed as follows:
(1) a first sub-circuit, arranged to perform human hand recognition upon the image data to generate a human hand recognition result, and obtain the hand gesture image data from the image data according to the human hand recognition result; and
(2) a second sub-circuit, arranged to perform the hand gesture detection upon the hand gesture image data to generate the at least one hand gesture detection result; but the present invention is not limited thereto. Specifically, regarding a first-stage operation in the two-stage operation, the first sub-circuit in the hand gesture detection circuit 215 may utilize the deep learning method or the neural network method to process each frame in the image data (e.g. utilize multiple different convolution kernels to perform multiple convolution operations upon the frame (e.g. the image frame), to recognize whether there is a human hand in the frame). In response to the human hand recognition result (e.g. when a human hand in the frame is recognized), the hand gesture detection circuit 215 can obtain the hand gesture image data from the image data. In addition, regarding a second-stage operation in the two-stage operation, the second sub-circuit in the hand gesture detection circuit 215 may utilize the deep learning method or the neural network method to process the hand gesture image data (e.g. utilize multiple different convolution kernels to perform multiple convolution operations upon the hand gesture image data, to recognize whether there is a predetermined hand gesture in the hand gesture image data). It should be noted that the circuit designs related to the human hand recognition and the hand gesture detection are similar to that of the above-mentioned person recognition, and are therefore well known to those with ordinary knowledge in the art. One of the key points of this embodiment is to perform subsequent operations according to the hand gesture detection result generated by the hand gesture detection circuit 215. As a result, details of the hand gesture detection circuit 215 are omitted here for brevity.

The voice activity detection circuit 220 is arranged to receive sound signals from the microphones 204_1-204_N, and determine whether there is a voice component in the sound signals. Specifically, the voice activity detection circuit 220 can perform the following operations: performing noise reduction upon the received sound signals; converting the sound signals to the frequency domain and then processing a block to obtain characteristic values; and comparing the obtained characteristic values with a reference value to determine whether the sound signals are voice signals. It should be noted that, since circuit designs related to the voice activity detection are well known to those with ordinary knowledge in the art, and one of the key points of this embodiment is to perform subsequent operations according to the determination result generated by the voice activity detection circuit 220, details of the voice activity detection circuit 220 are omitted here for brevity. In addition, in another embodiment, the voice activity detection circuit 220 can only receive sound signals from a part of the microphones 204_1-204_N, without receiving sound signals of all microphones 204_1-204_N.

Regarding operations of the sound direction detection circuit 230, the microphones 204_1 to 204_N can be placed at several known locations of the electronic device 110, so that the sound direction detection circuit 230 can determine an azimuth of a main sound in the first conference room (i.e. direction and angle of a main speaker relative to the electronic device 110) according to a time difference of sound signals from the microphones 204_1-204_N. In this embodiment, the sound direction detection circuit 230 can only determine one direction at a time; that is, if there are multiple people in the first conference room talking at the same time (or making other sounds), the sound direction detection circuit 230 will determine which direction the main sound comes from according to some characteristics (e.g. signal strength) of the received multiple sound signals. It should be noted that, since the circuit designs related to the sound direction detection circuit 230 are well known to those with ordinary knowledge in the art, and one of the key points of this embodiment is to perform subsequent operations according to a determination result generated by the sound direction detection circuit 230, details of the sound direction detection circuit 230 are omitted here for brevity.

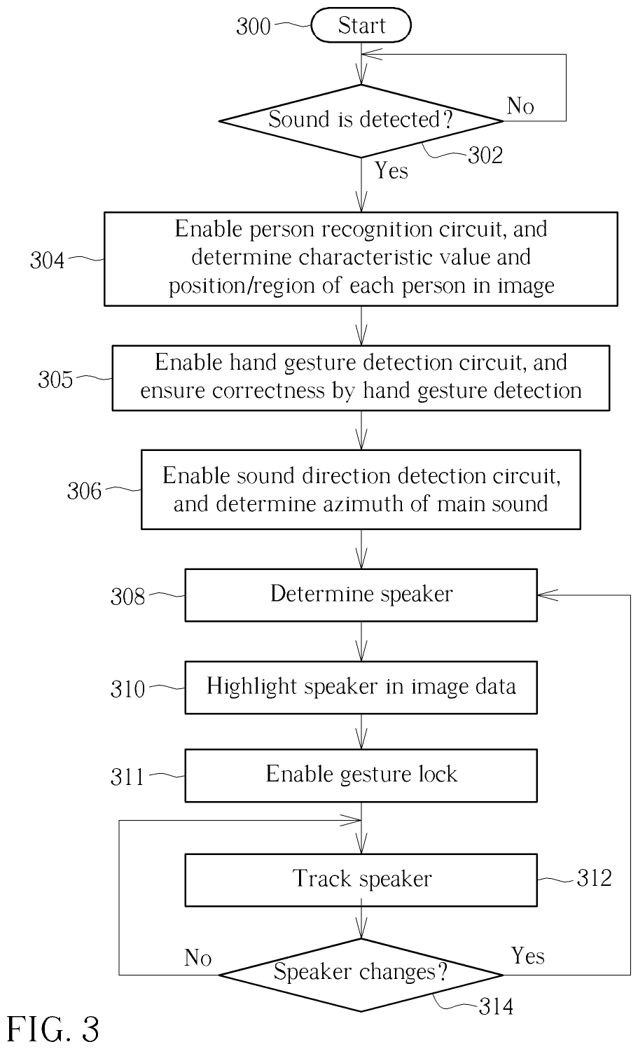

FIG. 3 is a flow chart of a video processing method according to an embodiment of the present invention, wherein the video processing method can be applicable to the SoC 200.

In Step 300, the flow starts, the electronic device 110 is powered on, and the connection with the electronic device 120 of the second conference room is completed.

In Step 302, the voice activity detection circuit 220 receives the sound signals from the microphones 204_1-204_N and determines whether there is a voice component in the sound signals. If yes, Step 304 is entered; if no, the flow returns to Step 302 to keep detecting whether there is a voice component in the sound signals.

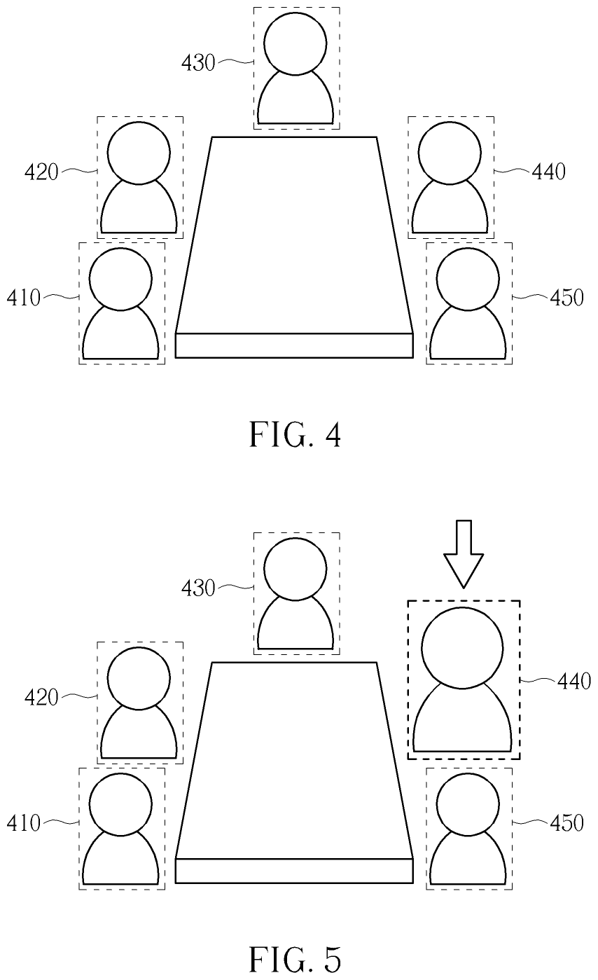

In Step 304, the processing circuit 304 enables the person recognition circuit 210 after the voice activity detection circuit 220 detects that the sound signals have the voice component, so that the person recognition circuit 210 starts to perform person recognition upon the received image data to determine whether there is a person in the received image data, and determines the characteristic value of each person and the position/region of each person in the image (e.g. the image displayed on the screen, such as the image frame). Take FIG. 4 as an example. The person recognition circuit detects that there are five people in the image, and therefore can determine regions 410-450 of each person in the image (e.g. the image frame) and determine the characteristic values of the image in the regions 410-450, respectively, as the characteristic value of each person.

In Step 305, the processing circuit 240 enables the hand gesture detection circuit 215 so that the hand gesture detection circuit 215 starts to perform hand gesture detection, to ensure correctness of related operations through the hand gesture detection.

In Step 306, the processing circuit 240 enables the sound direction detection circuit 230, and the sound direction detection circuit 230 starts to determine the direction and the angle of the main sound relative to the electronic device 110 according to the time difference of the sound signals from the microphones 240 1-240 N. It should be noted that Step 304, Step 305, and Step 306 may be executed simultaneously, i.e. the execution of this embodiment is not limited to the sequence shown in FIG. 3.

In Step 308, according to the region (e.g. the regions 410-450 shown in FIG. 4) of each person in the image (e.g. the image frame, such as the image data) determined by the person recognition circuit 210 and the direction and the angle of the main speaker relative to the electronic device 110 detected by the sound direction detection circuit 230, the processing circuit 240 can correctly determine the speaker in the image (e.g. the image frame) with the aid of a hand gesture detection result generated by the hand gesture detection circuit 215, and more particularly, determine that the current speaker in the image (e.g. the image frame such as the image data) is someone with a predetermined hand gesture (e.g. the person is raising his hand with the predetermined hand gesture), rather than any other person without the predetermined hand gesture (e.g. some other person is talking informally).

In Step 310, after determining the current speaker in the image (e.g. the image frame), the processing circuit 240 processes the image data from the image capturing device 202, to highlight the main speaker in the image data.

In Step 311, in addition to determining the region of the main speaker in the image (e.g. the image frame, such as the image data) and processing the image data to highlight the region, the processing circuit 240 further enables a gesture lock for the region, to indicate that the processing circuit 240 keeps highlighting the region. Specifically, FIG. 5 is a diagram of highlighting a current speaker in an image according to an embodiment of the present invention. It is assumed that the processing circuit 240 determines the person in the region 440 is the main speaker. The processing circuit 240 can process the image data to magnify the person in the region 440, or add labels/arrows, or any other image processing methods to enhance the visual effect of the person in the region 440. The processing circuit 240 then transmits the processed image data to the back-end circuit for other image processing, and transmits it to the electronic device 120 in the second conference room through the network, so that the participants in the second conference room can clearly identify the current speaker in the first conference room.

It should be noted that enhancing the visual effect of the person in the region 440 does not necessarily need to visually enhance the entire region 440, and only a part of the region 440 being visually enhanced can also achieve the same effect. Take FIG. 5 as an example. The region 440 includes the head and body of the person, and the processing circuit 240 can magnify only the head of the person.

In Step 312, the processing circuit 240 keeps tracking the highlighted person, and keeps processing the image data from the image capturing device 202 to highlight the person in the image data.

Specifically, the person recognition circuit 210 can keep determining the characteristic value and the region of each person in the image (e.g. the image frame), and the processing circuit 240 can keep highlighting the person in the current and subsequent image (e.g. the image frame) according to the characteristic value of the highlighted person. Take the region 440 in FIG. 5 as an example. The processing circuit 240 can track regions/persons with characteristic values similar to the characteristic value of the region 440 (e.g. the characteristic value difference is within a range) in the subsequently received image (e.g. the image frame), to keep highlighting the person in the subsequent image (e.g. the image frame), even if the highlighted person does not speak for a short period of time in the subsequent image (e.g. the image frame) and the sound direction detection circuit 230 does not detect sound in the direction of the person.

It should be noted that, since the current speaker may move (e.g. move from one position to another position in the first conference room), and may not keep speaking, Step 312 can prevent the image from turning on and turning off the visual effect for enhancing the speaker (which affects the feelings of the participants in the second conference room), but the present invention is not limited thereto. For example, after a period of time, the SoC 200 can perform the relevant determination operations again, and more particularly, determine the relative position and the characteristic value (or the characteristic value of the region where each person is located) of each person in detected people.

In Step 314, according to the region of each person in the image (e.g. the image frame) determined by the person recognition circuit 210, the direction and the angle of the main speaker relative to the electronic device 110 detected by the sound direction detection circuit 230, and the detection result indicating that someone is speaking (i.e. the received sound signal has the voice component) generated by the voice activity detection circuit 220, the processing circuit 240 can correctly determine whether the speaker changes with the aid of the hand gesture detection performed by the hand gesture detection circuit 215. If the determination is negative (e.g. none of the other people are speaking and raising their hands with the predetermined hand gesture), the method returns to Step 312 to keep tracking the current speaker. If the determination is positive (e.g. another person is speaking and raising their hand with the predetermined hand gesture), the method returns to Step 308 is returned to determine a new speaker. Specifically, the sound direction detection circuit 230 can only detect the direction of the sound and cannot know whether the sound in the determined direction is a human sound. As a result, under a condition that the voice activity detection circuit 220 detects that the current sound signal has the voice component, if the direction and the angle of the main speaker relative to the electronic device 110 detected by the sound direction detection circuit 230 changes to the position of another person, the processing circuit 240 can determine that the speaker has changed. It should be noted that, in order to prevent the processing circuit 240 from constantly changing the highlighted person in the image data, Step 314 maybe performed after a relatively long period of detection.

Some implementation details for the gesture lock can be further described as follows. According to some embodiments, the hand gesture detection result can indicate that the predetermined hand gesture is detected. In addition to determining a specific region (e.g. the region 440 in FIG. 5 where the current speaker is located) in the image (e.g. the image frame, such as the image data) and processing the image data to highlight the specific region, the processing circuit 240 can enable the gesture lock for the specific region (e.g. the region 440) for indicating the specific region should continue to be highlighted. In response to another hand gesture detection result, the processing circuit 240 can disable the gesture lock for the specific region. For example, the person in the region 440 shown in FIG. 5 can raise their hand again with the predetermined hand gesture, and the other hand gesture detection result (e.g. the aforementioned another hand gesture detection result) can indicate that the predetermined hand gesture is detected, wherein in response to the other hand gesture detection result, the processing circuit 240 can disable the gesture lock for the specific region (e.g. the region 440). In addition, according to multiple characteristic values (e.g. the characteristic values of the image in the regions 410-450, such as respective characteristic values of people in the regions 410-450) which correspond to multiple regions, respectively, and are determined by the person recognition circuit 210, a subsequent hand gesture detection result, the voice characteristic value of the main sound (e.g. the most recently detected sound such as the voice of the same person or another person, wherein the most recently detected sound can be regarded as the latest version of the main sound) detected by the sound direction detection circuit 230, and the detection result indicating whether the voice component is included in any sound signal generated by the voice activity detection circuit 220, the processing circuit 240 can determine whether the speaker changes for determining whether to select another region from the multiple regions as the specific region. Under a condition that the voice activity detection circuit 220 detects that the current sound signal has the voice component, if the direction and the angle of the main speaker relative to the electronic device 110 detected by the sound direction detection circuit 230 are changed to the position of another person, and the other person is raising his hand with the predetermined gesture, the processing circuit 240 can determine that the speaker has been changed to the other person.

According to some embodiments, it is assumed that the person in the region 440 shown in FIG. 5 does not raise his hand again using the predetermined hand gesture. As a result, the processing circuit 240 does not disable the gesture lock for the specific region. Under this situation, according to the multiple characteristic values (e.g. the characteristic values of the image in the regions 410-450, such as respective characteristic values of people in the regions 410-450) which correspond to multiple regions, respectively, and are determined by the person recognition circuit 210, the subsequent hand gesture detection result, the voice characteristic value of the main sound (e.g. the most recently detected sound) detected by the sound direction detection circuit 230, and the detection result indicating whether the voice component is included in any sound signal generated by the voice activity detection circuit 220, the processing circuit 240 can determine whether the speaker changes for determining whether to select another region from the multiple regions as the specific region. More particularly, no matter whether the gesture lock for the specific region has ever been disabled, in response to the subsequent hand gesture detection result, the processing circuit 240 can select the aforementioned another region from the multiple regions as the specific region. Under a situation that the voice activity detection circuit 220 detects that the current sound signal has the voice component, if the direction and the angle of the main speaker relative to the electronic device 110 detected by the sound direction detection circuit 230 are changed to the position of another person, and the other person is raising their hand with the predetermined gesture, the processing circuit 240 can determine that the speaker has been changed to the other person.

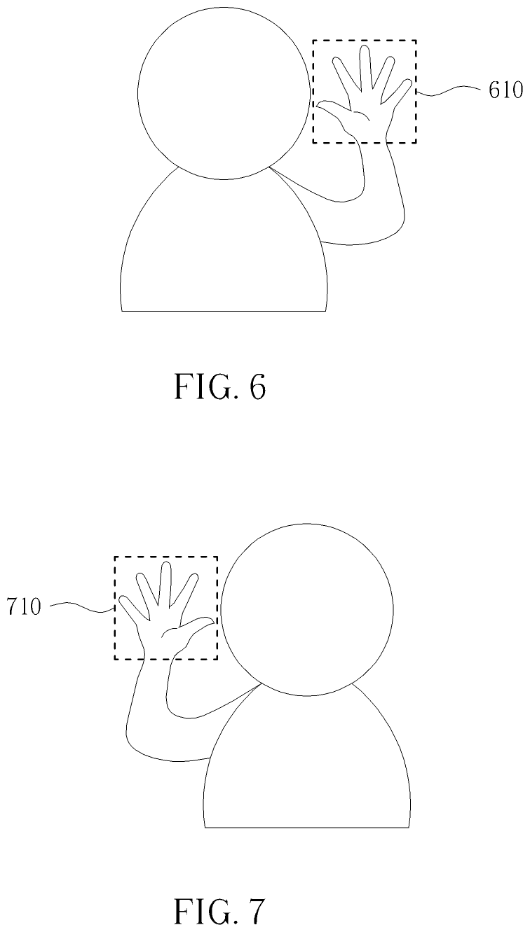

FIG. 6 is a diagram illustrating a predetermined hand gesture according to an embodiment of the present invention, wherein the predetermined hand gesture may be a predetermined hand gesture of the left hand. The hand gesture detection circuit 215 can utilize the first sub-circuit to perform the human hand recognition upon the image (e.g. the image frame such as the image data) , to generate the human hand recognition result, and obtain a partial image 610 from the image according to the human hand recognition result as a hand gesture image (e.g. the hand gesture image data). In addition, the hand gesture detection circuit 215 can utilize the second sub-circuit to perform the hand gesture detection upon the hand gesture image (e.g. the hand gesture image data) , to generate a corresponding hand gesture detection result. For brevity, similar descriptions for this embodiment are not repeated.

FIG. 7 is a diagram illustrating a predetermined hand gesture according to another embodiment of the present invention, wherein the predetermined hand gesture may be a predetermined hand gesture of the right hand. The hand gesture detection circuit 215 can utilize the first sub-circuit to perform the human hand recognition upon the image (e.g. the image frame such as the image data), to generate the human hand recognition result, and obtain a partial image 710 from the image according to the human hand recognition result as a hand gesture image (e.g. the hand gesture image data). In addition, the hand gesture detection circuit 215 can utilize the second sub-circuit to perform the hand gesture detection upon the hand gesture image (e.g. the hand gesture image data), to generate a corresponding hand gesture detection result. For brevity, similar descriptions for this embodiment are not repeated.

According to some embodiments, the hand gesture detection circuit 215 is not limited to perform the hand gesture detection with a single predetermined hand gesture, and more particularly, the predetermined hand gesture can be replaced by a predetermined hand gesture set, wherein the predetermined hand gesture set may include multiple predetermined hand gestures (e.g. the predetermined hand gestures shown in FIG. 6 and FIG. 7, respectively). For example, any person in the regions 410-450 can raise his hand with any predetermined hand gesture in the predetermined hand gesture set, and the processing circuit 240 can determine the speaker has been changed. For brevity, similar descriptions for this embodiment are not repeated in detail here.

According to some embodiments, a shape, type, direction, and/or finger count of the predetermined hand gestures in the predetermined hand gesture set may vary.

In another embodiment, in order to determine whether the speaker changes, the processing circuit 240 further includes a voiceprint recognition mechanism to support the detection result of the sound direction detection circuit 230. Specifically, since each person's voice has unique characteristics, the voiceprint recognition mechanism in the processing circuit 240 can continuously capture a part of sound clips to determine whether the voice characteristic values of these sound clips belong to the same person. For example, if the speaker is determined to be changed according to the person recognition circuit 210, the voice activity detection circuit 220, and the sound direction detection circuit 230, but the voiceprint recognition mechanism determines that the voice characteristic values of the sound clips belong to the same person, the processing circuit 240 can suspend determining whether the speaker has changed, and then make another determination after a period of time.

In the above embodiments, the sound direction detection circuit 230 is regarded as the sound detection circuit, but the present invention is not limited thereto. In other embodiments, the sound detection circuit can be equipped with the voiceprint recognition mechanism (e.g. a voiceprint recognition sub-circuit), and more particularly, the sound detection circuit can include the sound direction detection circuit 230 and the voiceprint recognition sub-circuit, and utilize the sound direction detection circuit 230 with the aid of the voiceprint recognition mechanism (e.g. the voiceprint recognition sub-circuit) to determine the speaker and the highlighted person. For example, the sound detection circuit of the present invention can receive and obtain multiple sound signals from multiple microphones to determine a voice characteristic value of a main sound, and the voice characteristic value can be a voiceprint (e.g. the voiceprint of sound clips detected by the voiceprint recognition sub-circuit) or an azimuth of the main sound.

In summary, the video processing method of the present invention can effectively improve video conference efficiency by detecting a current speaker and highlighting the speaker in the image data, thereby enabling participants in a remote conference room to clearly identify the speaker. In addition, the video processing method and the SoC of the present invention can ensure correctness of related operations using hand gesture detection, and more particularly, use gesture lock to keep highlighting the specific region, thereby avoiding any false highlighted region switching caused by an action of another person when the predetermined hand gesture is not used (e.g. some other person is talking informally).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system on chip (SoC), arranged to perform partial highlighting with aid of hand gesture detection, comprising:
a person recognition circuit, arranged to obtain an image data from an image capturing device, and perform person recognition upon the image data to generate a recognition result;
a hand gesture detection circuit, arranged to obtain the image data from the image capturing device, and perform hand gesture detection upon a hand gesture image data in the image data, to generate a hand gesture detection result;
a sound detection circuit, arranged to receive multiple sound signals from multiple microphones, and determine a voice characteristic value of a main sound; and
a processing circuit, coupled to the person recognition circuit, the hand gesture detection circuit, and the sound detection circuit, and arranged to determine a specific region in the image data according to the recognition result, the gesture detection result, and the voice characteristic value of the main sound, and process the image data to highlight the specific region.

2. The SoC of claim 1, further comprising:
a voice activity detection circuit, arranged to determine whether at least one part of the multiple sound signals comprises a voice component according to the multiple sound signals;
wherein according to whether the at least one part of the multiple sound signals comprises the voice component, the processing circuit determines the specific region in the image data according to the recognition result, the hand gesture detection result, and the voice characteristic value of the main sound.

3. The SoC of claim 2, wherein when the voice activity detection circuit indicates that the at least one part of the multiple sound signals comprises the voice component, the processing circuit determines the specific region in the image data according to the recognition result, the gesture detection result, and the voice characteristic value of the main sound, and processes the image data to highlight the specific region.

4. The SoC of claim 1, wherein the recognition result comprises multiple regions, and each of the multiple regions comprises a person; and the processing circuit selects a region from the multiple regions as the specific region according to the voice characteristic value of the main sound and the hand gesture detection result.

5. The SoC of claim 4, wherein the recognition result further comprises multiple characteristic values corresponding to the multiple regions, respectively, and the processing circuit tracks a characteristic value of the specific region to determine a location of the specific region in a subsequent image data, and processes the subsequent image data to highlight the specific region in the subsequent image data; the hand gesture detection result indicates that a predetermined hand gesture is detected;
the processing circuit is further arranged to enable a gesture lock for the specific region for indicating to keep highlighting the specific region; in response to another hand gesture detection result, the processing circuit disables the gesture lock for the specific region; and the SoC further comprises:
a voice activity detection circuit, arranged to determine whether at least one part of the multiple sound signals comprises a voice component according to the multiple sound signals;
wherein the processing circuit determines whether a speaker changes for determining whether to select another region from the multiple regions as the specific region according to the multiple characteristic values that correspond to the multiple regions, respectively, and are determined by the person recognition circuit, a subsequent hand gesture detection result, the voice characteristic value of the main sound determined by the sound detection circuit, and whether the at least one part of the multiple sound signals comprises the voice component determined by the voice activity detection circuit.

6. The SoC of claim 4, wherein the recognition result further comprises multiple characteristic values corresponding to the multiple regions, respectively, and the processing circuit tracks a characteristic value of the specific region to determine a location of the specific region in a subsequent image data, and processes the subsequent image data to highlight the specific region in the subsequent image data; the hand gesture detection result indicates that a predetermined hand gesture is detected;
in addition to determining the specific region in the image data and processing the image data to highlight the specific region, the processing circuit is further arranged to enable a gesture lock for the specific region for indicating to keep highlighting the specific region; and the SoC further comprises:
a voice activity detection circuit, arranged to determine whether at least one part of the multiple sound signals comprises a voice component according to the multiple sound signals;
wherein the processing circuit determines whether a speaker changes for determining whether to select another region from the multiple regions as the specific region according to the multiple characteristic values that correspond to the multiple regions, respectively, and are determined by the person recognition circuit, a subsequent hand gesture detection result, the voice characteristic value of the main sound determined by the sound detection circuit, and whether the at least one part of the multiple sound signals comprises the voice component determined by the voice activity detection circuit, wherein no matter whether the gesture lock for the specific region has ever been disabled, in response to the subsequent hand gesture result, the processing circuit selects said another region from the multiple regions as the specific region.

7. The SoC of claim 1, wherein the processing circuit processes the image data to magnify a person within the specific region.

8. The SoC of claim 1, wherein the voice characteristic value of the main sound is a voiceprint or an azimuth of the main sound.

9. The SoC of claim. 1, wherein the step of performing the hand gesture detection upon the hand gesture image data in the image data to generate the hand gesture detection result comprises:
performing a human hand recognition upon the image data to generate a human hand recognition result, and obtaining the hand gesture image data from the image data according to the human hand recognition result; and
performing the hand gesture detection upon the hand gesture image data to generate the hand gesture detection result.

10. A video processing method, arranged to perform partial highlighting with aid of hand gesture detection, comprising:
obtaining an image data from an image capturing device, and performing person recognition upon the image data to generate a recognition result;
obtaining the image data from the image capturing device, and performing hand gesture detection upon hand gesture image data in the image data, to generate a hand gesture detection result;
receiving multiple sound signals from multiple microphones, and determining a voice characteristic value of a main sound;
determining a specific region in the image data according to the recognition result, the gesture detection result, and the voice characteristic value of the main sound; and
processing the image data to highlight the specific region.
